(19) United States
(12) Patent Application Publication
(10) Pub. No.: US 2026/0065331 A1
(43) Pub. Date: Mar. 5, 2026

(54) INFORMATION PROCESSING APPARATUS AND INFORMATION PROCESSING METHOD

(71) Applicant: Hitachi, Ltd., Tokyo (JP)

(72) Inventors: Misu JEONG, Tokyo (JP); Takayuki AKAI, Tokyo (JP)

(21) Appl. No.: 19/066,547

(22) Filed: Feb. 28, 2025

(30) Foreign Application Priority Data
Aug. 29, 2024 (JP) 2024-147704

(51) Int. Cl. G06Q 30/0283

(52) U.S. Cl. CPC G06Q 30/0283

(57) ABSTRACT

An information processing apparatus includes: a storage apparatus that holds information about specifications required during each period, a cloud service, and various costs of the cloud service; and a processor that identifies combination patterns of candidate cloud services that meet the specifications during each period based on the information about the specifications and the cloud service, calculates a construction cost of the candidate cloud services during each period, a running cost, and a migration cost for each of the combination patterns, calculates a total cost for each of the combination patterns, and outputs information about a combination pattern whose total cost meets a predetermined criterion.

### CROSS-REFERENCE TO PRIOR APPLICATION

This application relates to and claims the benefit of priority from Japanese Patent Application number 2024-147704, filed on Aug. 29, 2024 the entire disclosure of which is incorporated herein by reference.

### BACKGROUND

The present invention relates generally to an information processing apparatus and an information processing method. In particular, the present invention relates to a technique that makes it possible to efficiently propose a suitable system configuration taking into consideration temporal changes in required specifications of the system.

In recent years, various cloud services have appeared, which are progressively being adopted by companies as one tool for promoting so-called digital transformation. On the other hand, even as this trend continues, only a limited number of companies have personnel with specialized skills and knowledge in this field. In response, managed services have been proposed for handling a series of tasks ranging from examining and constructing a company's ICT environment to its management and operation maintenance.

The above managed services require proposing, implementing, and the like of an accurate system configuration, taking into consideration the circumstances in which companies that wish to use the services are in. In such companies, however, there are cases in which various data, systems, and the like are siloed per task or department, making it is difficult to grasp the current situation the company is actually in.

With regard to the managed services such as described above, conventional techniques as disclosed in, for example, Japanese Patent Laid-Open No. 2022-129957 and Japanese Patent Laid-Open No. 2021-72017 are known. The technique as disclosed in Japanese Patent Laid-Open No. 2022-129957 is a technique for efficiently and appropriately performing assessment relating to usage of cloud services. The technique as disclosed in Japanese Patent Laid-Open No. 2021-72017 is a technique for efficiently creating new services that combine functions of a plurality of devices.

### SUMMARY

According to the conventional techniques, effectively grasping the circumstances a user is in is expected when introducing a combination of client services and the like. On the other hand, the contents, scale, and the like of business operations may change as time passes in each company being the user. Thus, there is a high possibility that the configuration and specifications of systems required for these business operations also change in due course. In other words, a case can easily occur in which it favorable for initially-expected specifications of a system to be upgraded, downgraded, revised or eliminated at some point.

However, no conventional technology has been proposed for supporting examination of the specifications taking into consideration changes in the specifications of the system which may change over time, in accordance with the above circumstances.

The present invention has been devised in view of the above problem and it is an object of the present invention to provide a technique that makes it possible to efficiently propose a suitable system configuration taking into consideration temporal changes in required specifications of the system.

An information processing apparatus according to an aspect of the present invention includes: a storage apparatus that holds information about specifications that are predicted to be required of a system of a user during each period, a cloud service used for system construction, a construction cost and a running cost of the cloud service, and a migration cost for migrating between two of the cloud services; and a processor that executes: processing of identifying combination patterns of candidate cloud services that meet the specifications required during each period, based on the information about the specifications and the cloud service; processing of calculating, for each of the identified combination patterns, a construction cost of the candidate cloud services during each period, a running cost during an operation period, and a migration cost when migrating the candidate cloud services between each period, based on the information about the construction cost, the running cost, and the migration cost; processing of calculating a total cost for each of the combination patterns, based on the construction cost, the running cost, and the migration cost calculated; and processing of selecting, from among the combination patterns, a combination pattern for which the total cost meets a predetermined criterion, and outputting information about the combination pattern.

The present invention makes it possible to efficiently propose a suitable system configuration taking into consideration temporal changes in required specifications of the system.

### BRIEF DESCRIPTION OF THE DRAWINGS

FIG. 1 is a diagram showing a network configuration including an information processing apparatus according to an embodiment.

FIG. 2 is a diagram showing a hardware configuration example of a configuration examination server according to the embodiment.

FIG. 3 is a diagram showing a hardware configuration example of a user terminal according to the embodiment.

FIG. 4 is a diagram showing an example of a formula according to the embodiment.

FIG. 5 is a diagram showing an example of a product pattern list table according to the embodiment.

FIG. 6 is a diagram showing an example of a construction experience value table according to the embodiment.

FIG. 7 is a diagram showing an example of a migration experience value table according to the embodiment.

FIG. 8 is a diagram showing an example of a limiting condition table according to the embodiment.

FIG. 9A is a diagram showing an example of an increase in specifications according to the embodiment.

FIG. 9B is a diagram showing an example of the specifications shrinking according to the embodiment.

FIG. 10 is a diagram showing an example of a combination list according to the embodiment.

FIG. 11 is a diagram showing an example of a cost table according to the embodiment.

FIG. 12 is a diagram showing a flow example of an information processing method according to the embodiment.

FIG. 13 is a diagram showing an output example according to the embodiment.

FIG. 14 is a diagram showing a flow example of the information processing method according to the embodiment.

FIG. 15 is a diagram showing an output example according to the embodiment.

### DESCRIPTION OF EMBODIMENTS

In the following description, a communication apparatus may be one or more communication interface devices. The one or more communication interface devices may be one or more communication interface devices of the same type (for example, one or more network interface cards (NICs)) or may be communication interface devices of two or more different types (for example, a NIC and a host bus adapter (HBA)).

In the following description, “memory” may be one or more memory devices being examples of one or more storage devices. At least one memory device in the memory may be a volatile memory device or may be a non-volatile memory device.

In the following description, “storage apparatus” may be one or more permanent memory devices being an example of one or more storage devices. The permanent storage device may typically be a non-volatile storage device. In particular, the permanent storage device may, for example, be a hard disk drive (HDD), a solid-state drive (SDD), or a non-volatile memory express (NVMe) drive.

In the following description, “CPU” is an arithmetic apparatus and may be one or more processor devices. At least one processor device may typically be a microprocessor device such as a central processing unit (CPU), but may also be a processor device of another type such as a graphics processing unit (GPU). At least one processor device may be single-core or may be multi-core. At least one processor device may be a processor core. At least one processor device may be a processor device in broad terms, such as a hardware circuit (for example, a field-programmable gate array (FPGA)) that performs a partial or an entirety of processing, a complex programmable logic device (CPLD), or an application-specific integrated circuit (ASIC).

In the following description, information obtained through output with respect to input may be described using expressions such as “*** table” or “*** database”, but the information may be data of any structure (for example, may be structured data or may be unstructured data), or may be a learning model which is typically a neural network, a genetic algorithm or a random forest that produces output with respect to input. Therefore, “*** table” or “*** database” can also be referred to as “*** information”. In the following description, a configuration of each database or table is one example. One database or table may be divided into two or more databases or tables, or a part or an entirety of two or more databases or tables may be one database or table.

In the following description, a case of processing is described with “program” as a subject thereof, but the subject of the processing may also be a CPU (or a device such as a controller including the processor), since predetermined processing is performed by appropriately using a storage apparatus, an interface apparatus, and/or the like, by executing the program via the CPU. The program may be installed on an apparatus such as a computer from a program source. The program source may, for example, be a (for example, non-transitory) recording medium readable by a program distribution server or the computer. In the following description, two or more programs may be implemented as one program or one program may be implemented as two or more programs.

In the following description, when elements of the same type are described without being distinguished from one another, common portions of reference signs may be used. When distinguishing elements of the same type from one another, reference signs or element identifiers may be used.

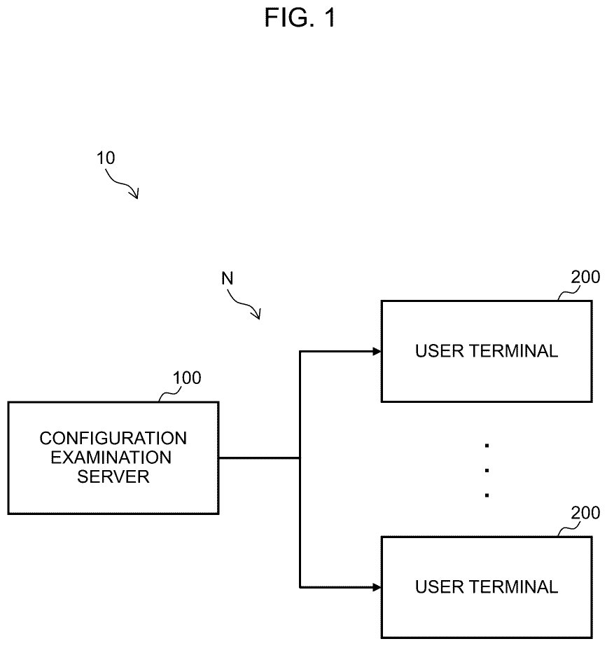

FIG. 1 is a diagram showing a network configuration including a configuration examination server 100 being an information processing apparatus according to the present embodiment.

The configuration examination server 100 according to the present embodiment is an apparatus that makes it possible to efficiently propose a suitable system configuration taking into consideration temporal changes in required specifications in the system, and corresponds to a server apparatus operated by a business operator that provides managed services relating to the system. The configuration examination server 100 is data-communicably connected to user terminals 200 via a network N, and may constitute an information processing system 10.

The configuration examination server 100 constituting such an information processing system 10 as a main component is a server apparatus operated by a business operator that provides so-called managed services. In this case, when providing the managed services, the business operator conducts an interview concerning system specifications desired by a user, chronological changes in the specifications, and the like, and allows a result of the interview to be used and managed in the configuration examination server 100. Alternatively, substituting or supplementing such an interview, various information about the user (for example, scale, content, personnel of company or target business, personnel, attributes of target customers, and the like) may be used as input in an appropriate algorithm (for example, a large-scale language model or the like) to estimate the system specifications, the changes in the system, and the like. The configuration examination server 100 is not limited to being used by the above business operator, and may be used or operated by a user of the managed services (the user according to the present embodiment).

Information examined by the configuration examination server 100, that is, information about a system configuration in which various cloud services are combined, changes in the configuration over time, and the like is distributed to the user terminal 200 of a corresponding user via the network N or output via an output apparatus included in the configuration examination server 100.

As described above, the configuration examination server 100 constituting the information processing system 10 is communicably connected to each of the user terminals 200 via the appropriate network N proper. Each of the user terminals 200 is a terminal that is connected to the configuration examination server 100, and acquires and outputs information configuration proposal information about a business system and the like of a corresponding user. Actually, viewing and confirming the information on the user terminal 200 is a person-in-charge of construction, operation, and the like of the business system.

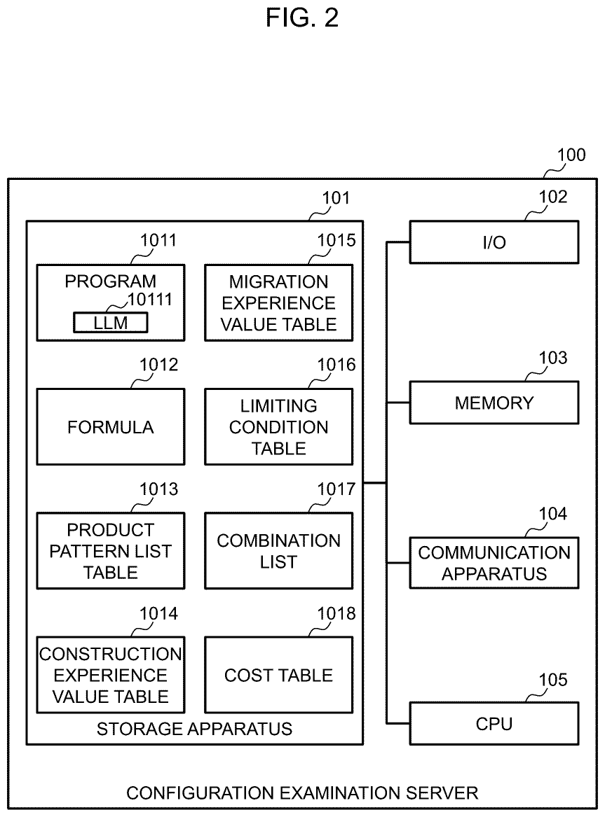

The configuration examination server 100 shown in FIG. 1 and FIG. 2 includes a storage apparatus 101 implemented as a non-volatile storage apparatus such as a hard disk drive or an embedded MultiMediaCard, an I/O 102 for connection to an input apparatus such as a keyboard and an output apparatus such as a display, a memory 103 implemented as a volatile storage apparatus such as random-access memory (RAM), communication apparatus 104 that is connected to the network N and performs communication with at least the user terminals 200, and a CPU 105 (processor) that loads a program 1011 held by the storage apparatus 101 to the memory 103 and performs various determination, calculation, and control processing as well as its own integrated control.

Information stored in the storage apparatus 101 in the above configuration examination server 100 is a formula 1012, a product pattern list table 1013, a construction experience value table 1014, a migration experience value table 1015, a limiting condition table 1016, a combination list 1017, and a cost table 1018. These pieces of information will be described in detail below. An LLM 10111 used by being appropriately loaded by the program 1011 is held by the storage apparatus 101. The LLM 10111 is a model that fulfills, for example, a function of estimating information such as required specifications and changes over time of the business system of the user, substituting or supplementing the above interview with the user. Thus, machine learning in accordance with the function is implemented in advance using predetermined training data.

Note that a part of processing performed through the CPU 105 executing the program 1011 may be executed by another arithmetic apparatus (for example, hardware such as an ASIC or an FPGA). The memory 103 may be read-only memory (ROM) being a non-volatile storage element. The ROM is stored in an immutable program (for example, a BIOS). The RAM is a high-speed and volatile storage elements such as a dynamic random-access memory (DRAM), and temporarily stores the program 1011 executed by the CPU 105 and data used when executing the program 1011.

The user terminals 200 connected to the configuration examination server 100 via the network N may each be provided with the input apparatus and the output apparatus described above. The program 1011 executed by the CPU 105 is provided to the configuration examination server 100 via removable media (CD-ROM, flash memory, or the like) or the network N, and is stored in the non-volatile storage apparatus 101 being a non-transitory storage medium.

Accordingly, the configuration examination server 100 reads data from the removable media via the above I/O 102. The configuration examination server 100 is a computer system running on one physical computer, or logically or physically running on a plurality of computers. The configuration examination server 100 may operate on a virtual computer constructed from resources of a plurality of physical computers. The configuration examination server 100 may be implemented on a cloud, or may be implemented on on-premises equipment consisting of a specific computer (hardware).

Note that the network N connecting the configuration examination server 100 and the user terminals 200 may be assumed to be the Internet, a local area network (LAN), a wide area network (WAN), a mobile telephone network, or the like, but is not limited thereto.

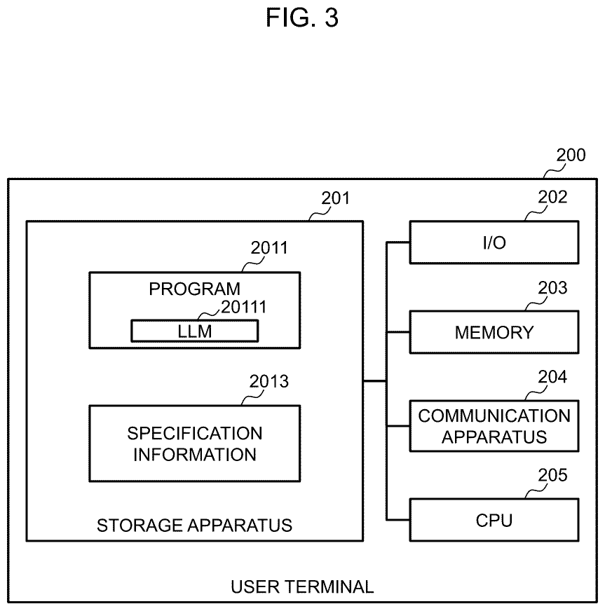

On the other hand, the user terminals 200 connected to the network N each include, as shown in FIG. 3, a storage apparatus 201, an I/O 202, a memory 203, a communication apparatus 204, and a CPU 205, similar to the above configuration examination server 100. In the storage apparatus 201, a program 2011 and information relating to the required specifications and changes over time of the business system of the user, that is, specification information 2013 are held.

Note that the program 2011 may further include an LLM 20111 having a similar function as the LLM 10111 held by the above configuration examination server 100. In this case, the LLM 20111 generates the specification information 2013. In particular, such user terminals 200 may each be implemented in the form of a personal computer (PC), a tablet terminal, a smartphone, or the like.

Data transmission and reception between the configuration examination server 100 and the user terminals 200 may, for example, be implemented in accordance with an application programming interface (API) protocol. In this case, a function and a configuration for executing request and response processing through API may be implemented in advance in all equipment.

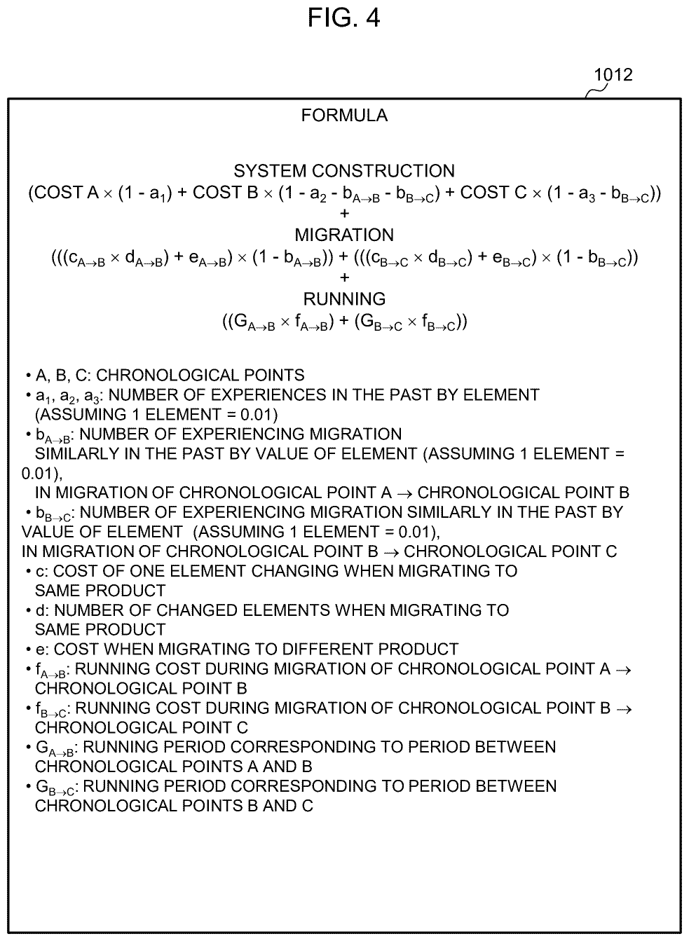

The formula 1012 used by the configuration examination server 100 according to the present embodiment will be described with reference to FIG. 4.

The formula 1012 is a formula of an estimated cost of introduction and operation of a business system for a user, and is a mathematical expression in the form of adding up variables relating to system construction, migration, and running. The formula 1012 corresponds to that the specifications of the business system of the user may change chronologically. In FIG. 4, the formula 1012 corresponds to content defining specifications at chronological points A, B, and C.

That is, with regards to chronological point A as a starting point, the cost of system construction is calculated by adding up a value obtained by multiplying “cost A” with a coefficient (1−a₁) that decreases as a past construction experience number a₁ increases; a value obtained by multiplying “cost B” with a coefficient (1−a₂-b_{A→B}-b_{B→C}) that decreases as a past construction experience number a₂, a past migration experience number b_{A→B} (migration from cloud service A to cloud service B), and a past migration experience number b_{B→C} (migration from cloud service B to cloud service C) increase; and a value obtained by multiplying “cost C” with a coefficient (1-a₃-b_{B→C}) that decreases as a past construction experience number a₃ and a past migration experience number b_{B→C} (migration from cloud service B to cloud service C) increase.

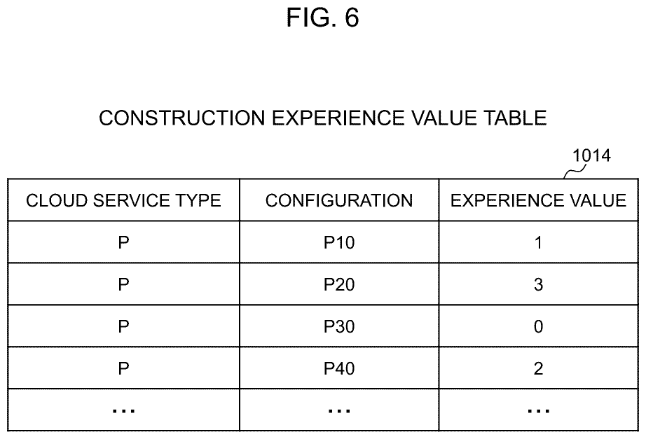

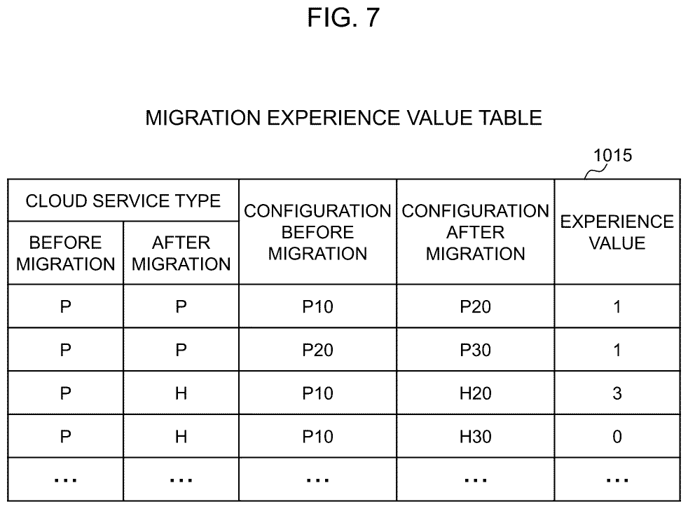

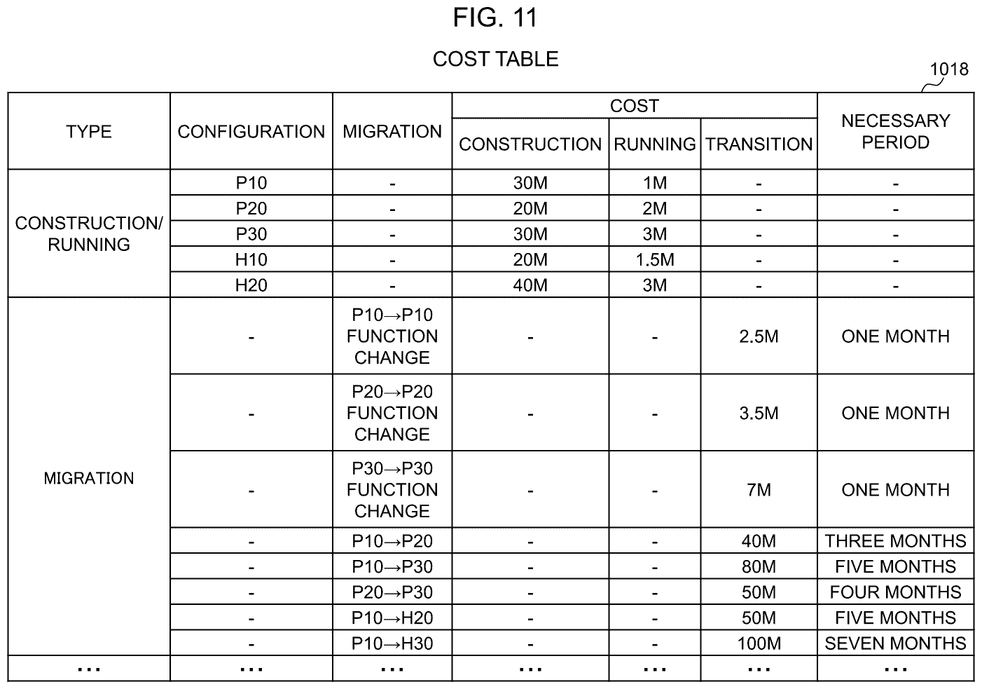

Note that the above “cost A”, “cost B”, and “cost C” are values indicating the construction cost of certain cloud services when construction is assumed to be starting at chronological point A, and can be set by being read from the cost table 1018 (FIG. 11), as the construction cost of candidate cloud services for each period (chronological points A to C) identified by the configuration examination server 100. Each construction experience number and migration experience number value is a value that can be set by being read from the construction experience value table 1014 (FIG. 6) and the migration experience value table 1015 (FIG. 7).

The migration cost is calculated by adding up each total value obtained by (i) multiplying a sum of a value obtained by multiplying unit cost C_{A→B} in a migration mode of changing a unit element (unit function) in one product (same cloud service) with element number d_{A→B} changed in the product and migration cost e_{A→B} when migrating between different products (between different cloud services) with a coefficient that decreases in accordance with the past migration experience number b_{A→B} increasing, between chronological points A and B, and (ii) multiplying a sum of a value obtained by multiplying unit cost C_{B→C} in a migration mode of changing a unit element (unit function) in one product (same cloud service) with element number de-c changed in the product and migration cost e_{B→C} when migrating between different products (between different cloud services) with a coefficient that decreases in accordance with the past migration experience number b_{B→C} increasing, between chronological points B and C. Note that the unit costs accompanying the change in the above unit elements (function change in same cloud service) are also values that can be set by being read from the cost table 1018 (FIG. 11).

The running cost is calculated by adding up (i) a value obtained by multiplying a running period G_{A→B} corresponding a period between chronological points A and B with running cost f_{A→B} per unit period of a target product (cloud service) operated in the period, and (ii) a value obtained by multiplying a running period G_{B→C} corresponding a period between chronological points B and C with running cost f_{B→C} per unit period of a target product (cloud service) operated in the period. Note that the running costs per unit period are also values that can be set by being read from the cost table 1018 (FIG. 11).

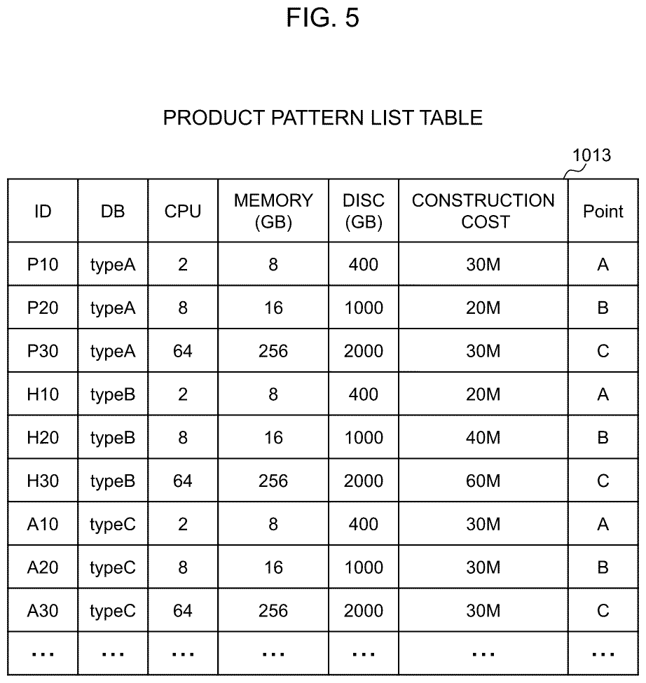

Next, a specific configuration example of various tables used by the configuration examination server 100 according to the present embodiment will be described with reference to FIG. 5 to FIG. 11.

FIG. 5 is a diagram showing a configuration example of the product pattern list table 1013 according to the present embodiment.

The product pattern list table 1013 is a table in which a result is stored of identifying combination patterns of cloud services that the configuration examination server 100 requires at each chronological point.

Such a product pattern list table 1013 is an aggregation of records in which the type of database, the number of CPUs, memory capacity, disk capacity, and construction cost values of cloud services are associated with the chronological points, as sorted by ID uniquely identifying the cloud services. In the example of FIG. 5, “P10”, “P20”, “P30”, “H10”, “H20”, “H30”, “A10”, “A20”, and “A30” are listed as cloud services, and are associated with values indicating a corresponding configuration, function, construction cost, and the like.

FIG. 6 is a diagram showing a configuration example of the construction experience value table 1014 according to the embodiment.

The construction experience value table 1014 is a table in which information relating to cloud services construction experience of the business operator itself providing the managed services is stored. Such a construction experience value table 1014 is an aggregation of records with which the construction experience number of the cloud service is associated as sorted by ID uniquely identifying the type and the configuration of the cloud services. In the example of FIG. 6, experience values relating to each cloud service are associated with configurations “P10” to “P40” being of type “P”.

FIG. 7 is a diagram showing a configuration example of the migration experience value table 1015 according to the present embodiment.

The migration experience value table 1015 is a table in which information relating to cloud services migration experience of the business operator itself providing the managed services is stored. Such a migration experience value table 1015 is an aggregation of records with which a migration experience number between the cloud services is associated, as sorted by ID uniquely identifying the type and the configuration of the cloud services before and after migration. In the example of FIG. 7, experience values relating to migration between each cloud service are associated with configurations “P10”, “P20”, “P30”, “H20”, and “H30” being of cloud service type “P” and “H”.

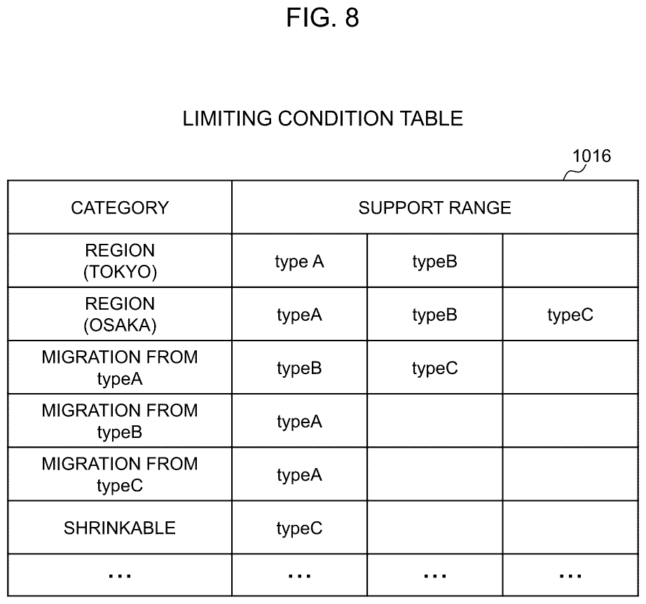

FIG. 8 is a diagram showing a configuration example of the limiting condition table 1016 according to the present embodiment.

The limiting condition table 1016 is a table in which information about limiting conditions determined by the business operator providing the managed services in accordance with the type of the cloud services is stored. Such a limiting condition table 1016 is an aggregation of records with which information about the types of databases (can also be referred to as the types of cloud services) that conform to limiting conditions defined by the categories, that is, that are in a support range is associated, as sorted by “category” uniquely identifying the category of the limiting conditions. The example of FIG. 8 shows that, for example, a database of a cloud service conforming to a category “region (Tokyo)” is of “typeA” and “typeB”, and a database of a cloud service conforming to a category “region (Osaka)” is of “typeA”, “typeB”, and “typeC”. The example of FIG. 8 further shows that a database of a cloud service conforming to a category “migration from typeA” is of “typeB” and “typeC”, a database of a cloud service conforming to a category “migration from typeB” is of “typeA”, and a cloud service conforming to a category “migration from typeC” is of “typeA”. The example of FIG. 8 further shows that a database of a cloud service conforming to a condition “shrinkable” is of “typeC”.

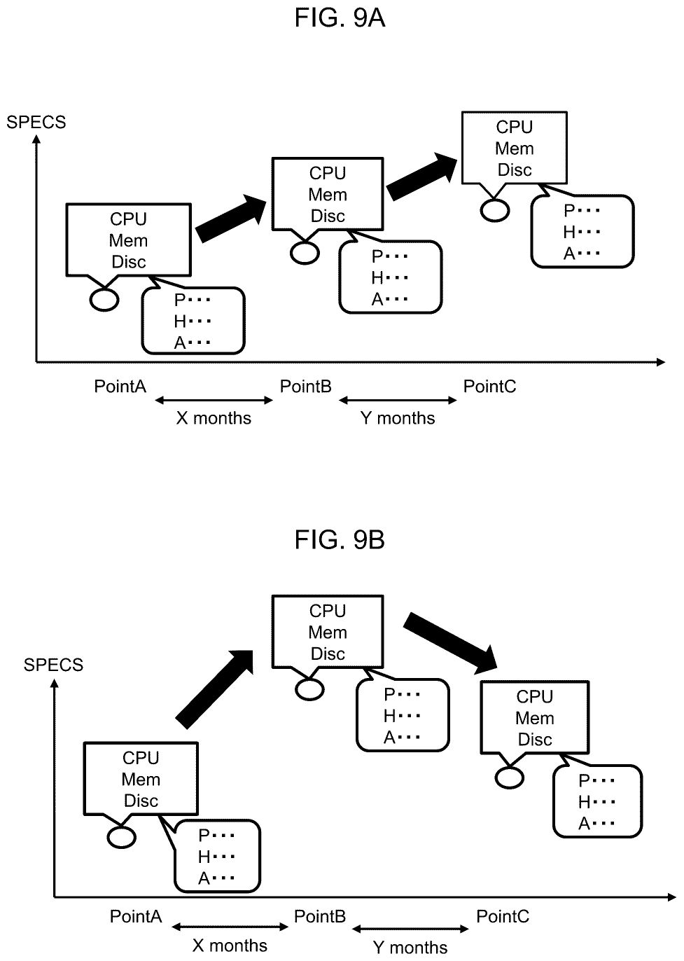

Note that, as described above, specific visualizations of a case in which required specifications increase or shrink over time, that is, the chronological points are shown respectively in FIG. 9A and FIG. 9B. FIG. 9A shows a state in which required specifications (specs) increase over time from chronological point A to chronological point B and from chronological point B toward chronological point C. On the other hand, FIG. 9B shows a state in which required specifications (specs) increase from chronological point A toward chronological point B, but decrease, that is, shrink over time from chronological point B toward chronological point C.

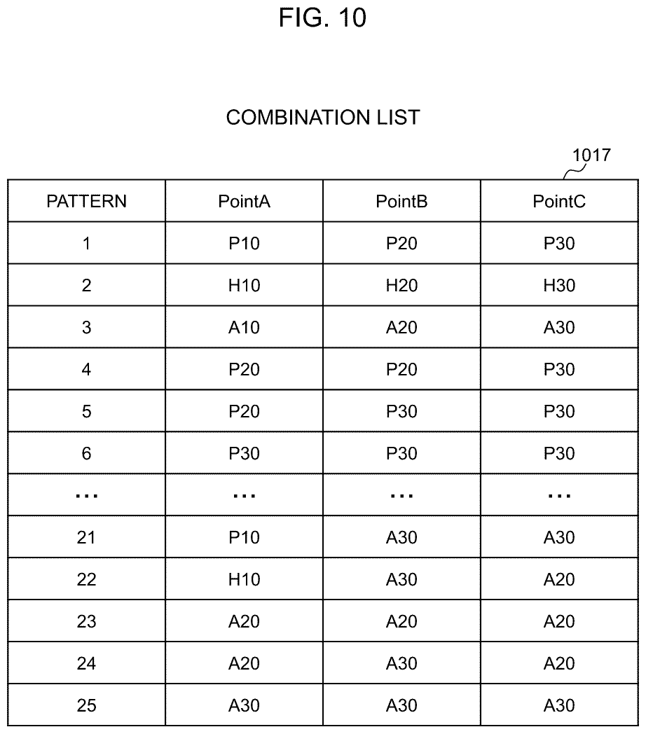

FIG. 10 is a diagram showing a configuration example of the combination list 1017 according to the present embodiment.

The combination list 1017 indicates combination patterns of candidate cloud services identified by the configuration examination server 100 according to the present embodiment. The combination list 1017 is an aggregation of records in which candidate cloud services meeting specifications required by the user are a set per pattern for each of the chronological points (A to C).

FIG. 11 is a diagram showing a configuration example of the cost table 1018 according to the present embodiment.

The cost table 1018 is a table defining each cost of construction, running, and migration of the cloud services. The cost table 1018 is an aggregation of records in which each cost of construction, running, and migration with respect to each condition of the configuration and a migration target of the cloud service is associated with a required period of time for construction and migration, with regards to the circumstances of the construction, running, and migration of the cloud services. Note that the cost for category “migration” is not only the migration cost between different cloud services, but also prescribes a rate when only functions are changed in one cloud service.

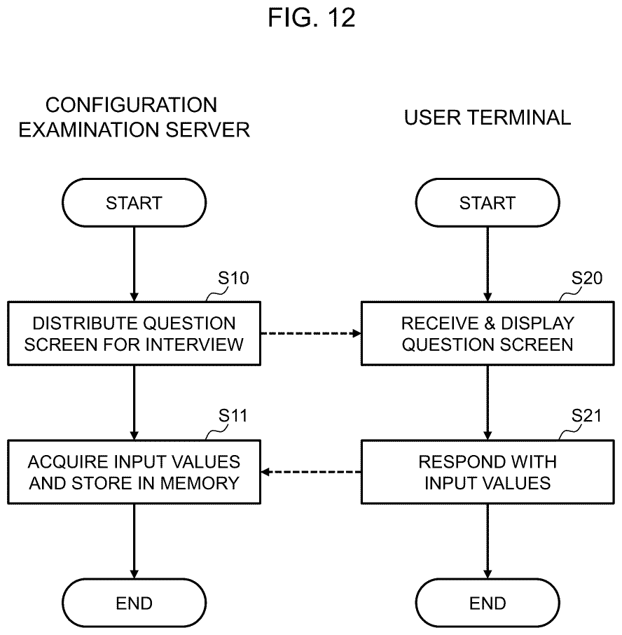

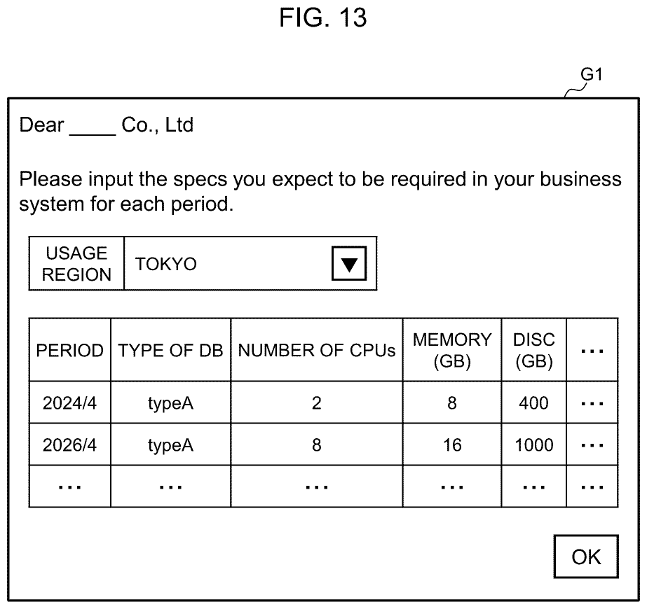

Next, a processing flow of an information processing method according to the present embodiment will be described with reference to FIG. 12 and FIG. 13.

FIG. 12 is a diagram showing a flow example of the information processing method according to the present embodiment. FIG. 13 is a diagram showing an output example according to the present embodiment. Here, the configuration examination server 100 and the user terminals 200 cooperate, and a series of processing is shown for acquiring information about system specifications desired by the user or assumed to be desired by the user and chronological changes thereof.

First, the configuration examination server 100, for example, distributes a question screen G1 (see FIG. 13) held in advance by the configuration examination server 100 to the user terminal 200 (S10). In response, the user terminal 200 receives the question screen G1 distributed from the configuration examination server 100 and displays this to an output apparatus such as a display (S20). The above question screen G1 asks about the specifications required by the user at each chronological point. The user inputs the values of the specifications required at each period, as well as a usage region of the business system on the screen G1.

The user terminal 200 responds to the configuration examination server 100 via the network N with the values that the user has input on the screen G1 (S21). In response, the configuration examination server 100 acquires the response from the user terminal 200, and, for example, temporarily stores the response in the memory 103 (S11) and ends the present flow.

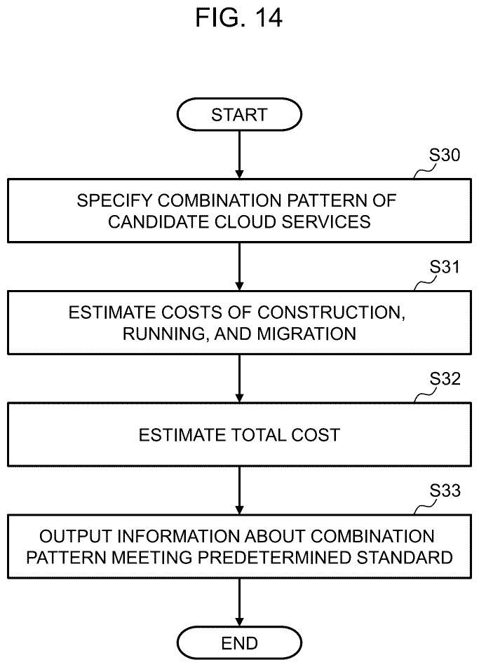

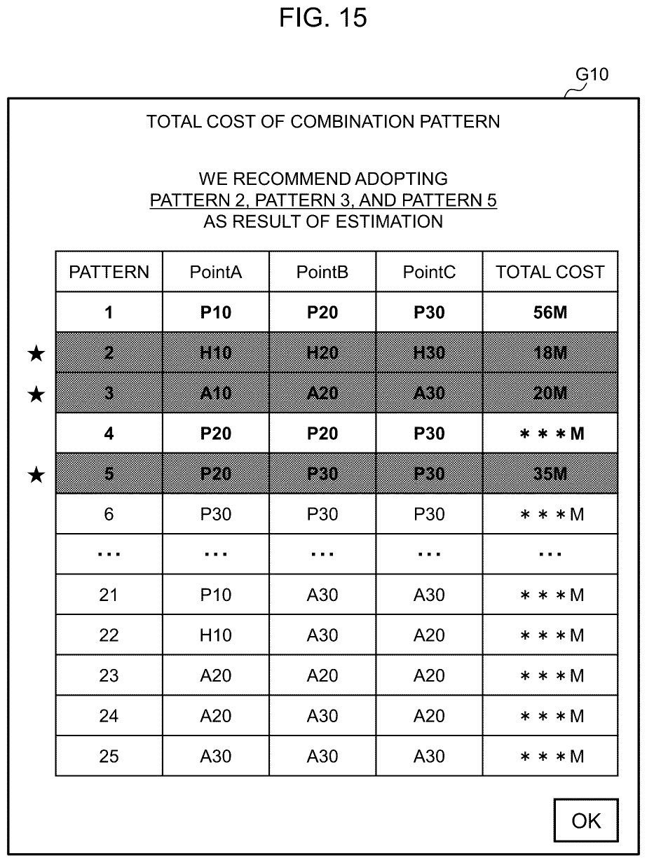

Next, processing of identifying a combination of candidate cloud services that meet the specifications at each period and are cost-effective from among a number of cloud services, based on the values input on the question screen G1 obtained from the user in the above flow, that is, based on the specifications desired by the user and the chronological changes thereof, will be described in FIG. 14 and FIG. 15. FIG. 14 is a diagram showing a flow of the information processing method according to the present embodiment. FIG. 15 is a diagram showing an output example according to the present embodiment.

In this case, the configuration examination server 100 identifies a combination pattern of candidate cloud services meeting the specifications required at each period as designated by the user, based on information about the specifications stored in the memory 103 as acquired in the above flow and the chronological changes thereof and the information in the product pattern list table 1013 held in the storage apparatus 101 (S30).

In this case, the configuration examination server 100 searches for cloud services meeting the specifications of database type, number of CPUs, memory capacity, and disk capacity per chronological point from each cloud service defined in the product pattern list table 1013, and identifies these as candidate cloud services. The configuration examination server 100 comprehensively generates pattern of candidate cloud services acquired in this manner and assigned to each chronological point, which becomes the combination list 1017.

Note that, when identifying the above combination pattern, the configuration examination server 100 cross-checks the cloud services constituting the combination patterns and the information obtained from the above user (held in the memory 103) against the information of the limiting condition table 1016 and eliminates cloud services that are incompatible with the restrictions indicated by the limiting conditions. For example, when the region where the user uses the business system is “Tokyo”, only a cloud service whose database type is “typeA” or “typeB” is adopted as a candidate cloud service for the combination pattern.

Next, the configuration examination server 100 calculates the construction cost of the candidate cloud service at each chronological point, the running cost during the operation period, and the migration cost when migrating the candidate cloud service between each chronological point, based on the construction and running cost and the information about the migration cost for each combination pattern identified in the above S30 (S31).

Such calculation of each of the costs is performed by inputting the corresponding values acquired in the processing up to this point and the corresponding values in the cost table 1018 (unit cost for construction, running, and migration, period of time required for migration, and the like) with respect to each variable in the formula 1012. As already mentioned in the description relating to the formula 1012, when calculating the above construction cost and migration cost, the construction cost and the migration cost are reduced to a certain degree in accordance with the presence/absence or degree of construction experience of the candidate cloud services and migration experience of the candidate cloud services possessed by the business operator providing the managed services.

The configuration examination server 100 calculates a total cost for each of the combination patterns, based on the construction cost, the running cost, and the migration cost calculated in the above S31 (S32). This calculation is acquired by executing the above formula 1012.

The configuration examination server 100 selects a combination pattern from among the combination pattern whose total cost meets a predetermined criterion, outputs information about the combination pattern (the screen G10 in FIG. 15) to, for example, the user terminal 200 via the network N (S33), and ends the present flow. The example of screen G10 shown in FIG. 15 shows a screen configuration with a star at a left end of the record as a pattern with relatively low total cost for patterns “2”, “3”, and “5”.

As described above, the information processing system according to the present embodiment allows for efficient and accurate prompt-tuning while maintaining data confidentiality for each LLM user.

Note that the present invention is not limited to the embodiments described above, and includes various modifications and equivalent configurations within the spirit of the appended claims. For example, the embodiments described above have been described in detail for easy understanding of the present invention, and the present invention is not necessarily limited to including all of the configurations described above. A part of the configuration of one embodiment can be replaced with the configuration of another embodiment. The configuration of another embodiment can be added to the configuration of one embodiment. A part of the configuration of each embodiment may be subjected to addition, deletion and replacement of another configuration.

Some or all of the above-described configurations, functions, processing units, processing means, and the like may be implemented in hardware by designing, for example, an integrated circuit, or may be implemented in software by a processor interpreting and executing a program that implements respective functions.

Information such as a program, a table, and a file that implements each function can be stored in a storage apparatus such as a memory, a hard disk, and a solid-state drive (SSD), or a recording medium such as an Integrated Circuit (IC) card, an SD card, and a digital versatile disc (DVD).

Control lines and information lines indicate what is considered necessary for explanation, and not all control lines and information lines being necessary in the products are shown. It may be considered that almost all the configurations are actually connected to each other.

The above description can be summarized as follows. The following summary may include description of supplements and description of modifications. In the information processing apparatus according to the present embodiment, the storage apparatus may further hold information about an attribute of the user; and information about a limiting condition specified for the cloud service, the limiting condition relating to at least one of an applicable region, migratability between cloud services, or function expandability/shrinkability. When identifying the combination patterns, the processor may cross-check cloud services constituting the combination patterns and the information about the attribute of the user against the information about the limiting condition and eliminate cloud services that are incompatible with restrictions indicated by the limiting condition.

This makes it possible to efficiently identify the above combination patterns based on the conformity of the target user's service usage area, required (predicted) specification level, migration schedule, and the like, with respect to each condition, such as limitation of applicable region of cloud services, migration, and functionality expansion/shrinking. Consequently, it is possible to efficiently propose a suitable system configuration taking into consideration temporal changes in the required specifications of the system.

In the information processing apparatus according to the present embodiment, the storage apparatus may further hold information relating to construction experience of the cloud service and migration experience between cloud services, with regards to a business operator providing the user with a managed service. When calculating the construction cost and the migration cost, the processor may reduce the construction cost and the migration cost to a certain degree in accordance with the presence/absence or degree of construction experience of the candidate cloud services and migration experience of the candidate cloud services possessed by the business operator.

This makes it possible to calculate the costs taking into consideration the possibility of cost reduction in accordance with the business experience of the business operator providing the managed services. Consequently, this makes it possible to efficiently propose a suitable system configuration taking into consideration temporal changes in the required specifications of the system.

In the information processing apparatus according to the present embodiment, the processor may acquire, via a predetermined input apparatus or a terminal of the user, information about the specifications required during each period for the user and stores the information in the storage apparatus.

This makes it possible to directly check the circumstances, predictions, and the like of the user desiring to use the managed services, and reflect this content in the processing according to the present embodiment. Consequently, it is possible to efficiently propose a suitable system configuration taking into consideration temporal changes in the required specifications of the system.

1. An information processing apparatus, comprising:
a storage apparatus that holds information about: specifications that are predicted to be required of a system of a user during each period, a cloud service used for system construction, a construction cost and a running cost of the cloud service, and a migration cost for migrating between two of the cloud services, and information being numerical values relating to construction experience of the cloud service and migration experience between cloud services, with regards to a business operator providing the user with a managed service; and
a processor that executes:
processing of identifying combination patterns of candidate cloud services that meet the specifications required during each period, based on the information about the specifications and the cloud service,
processing of calculating, for each of the identified combination patterns, a construction cost of the candidate cloud services during each period, a running cost during an operation period, and a migration cost when migrating the candidate cloud services between each period, based on the information about the construction cost, the running cost, and the migration cost,
processing of calculating a total cost for each of the combination patterns, based on the construction cost, the running cost, and the migration cost calculated, and
processing of selecting, from among the combination patterns, a combination pattern for which the total cost meets a predetermined criterion, and outputting information about the combination pattern, and
when calculating the construction cost and the migration cost, processing of reducing the construction cost and the migration cost to a predetermined degree in accordance with the presence/absence or degree of a construction experience value of the candidate cloud services and a migration experience value of the candidate cloud services possessed by the business operator.

2. The information processing apparatus according to claim 1, wherein
the storage apparatus further holds:
information about an attribute of the user; and
information about a limiting condition specified for the cloud service, the limiting condition relating to at least one of an applicable region, migratability between cloud services, or function expandability/shrinkability, and
when identifying the combination patterns, the processor cross-checks cloud services constituting the combination patterns and the information about the attribute of the user against the information about the limiting condition and eliminates cloud services that are incompatible with restrictions indicated by the limiting condition.

3. (canceled)

4. The information processing apparatus according to claim 1, wherein the processor acquires, via a predetermined input apparatus or a terminal of the user, information about the specifications required during each period for the user and stores the information in the storage apparatus.

5. An information processing method comprising:
holding, in a storage apparatus of an information processing apparatus, information about: specifications that are predicted to be required of a system of a user during each period, a cloud service used for system construction, a construction cost and a running cost of the cloud service, and a migration cost for migrating between two of the cloud services, the information being held in a storage apparatus, and information relating to construction experience of the cloud service and migration experience between cloud services, with regards to a business operator providing the user with a managed service; and
executing, by the information processing apparatus:
processing of identifying combination patterns of candidate cloud services that meet the specifications to be required during each period, based on the information about the specifications and the cloud service;
processing of calculating, for each of the identified combination patterns, a construction cost of the candidate cloud services during each period, a running cost during an operation period, and a migration cost when migrating the candidate cloud services between each period, based on the information about the construction cost, the running cost, and the migration cost;
processing of calculating a total cost for each of the combination patterns, based on the construction cost, the running cost, and the migration cost calculated; and
processing of selecting, from among the combination patterns, a combination pattern for which the total cost meets a predetermined criterion, and outputting information about the combination pattern; and
when calculating the construction cost and the migration cost, processing of reducing the construction cost and the migration cost to a predetermined degree in accordance with the presence/absence or degree of construction experience of the candidate cloud services and migration experience of the candidate cloud services possessed by the business operator.
